(19) United States
(12) Patent Application Publication
(10) Pub. No.: US 2014/0111452 A1
(43) Pub. Date: Apr. 24, 2014

(54) TERMINAL AND METHOD OF CONTROLLING TOUCH OPERATIONS IN THE TERMINAL

(71) Applicant: Electronics and Telecommunications Research Institute, Daejeon (KR)

(72) Inventors: Juyoung PARK, Daejeon (KR); Do Young KIM, Daejeon (KR)

(73) Assignee: Electronics and Telecommunications Research Institute, Daejeon (KR)

(21) Appl. No.: 14/061,691

(22) Filed: Oct. 23, 2013

(30) Foreign Application Priority Data
Oct. 23, 2012 (KR) 10-2012-0118125
Sep. 24, 2013 (KR) 10-2013-0113443

(51) Int. Cl. G06F 3/041; G06F 3/01

(52) U.S. Cl. CPC G06F 3/041; G06F 3/013
USPC 345/173

(57) ABSTRACT

A terminal including an eye-tracking unit for tracking a gaze of a user to generate gaze information, a touch sensing unit for sensing a touch of the user to generate touch information, and a controller for performing a touch operation based on the gaze information and the touch information are provided.

### CROSS-REFERENCE TO RELATED APPLICATION

This application claims priority to and the benefit of Korean Patent Application No. 10-2012-0118125 and 10-2013-0113443 filed in the Korean Intellectual Property Office on Oct. 23, 2012 and Sep. 24, 2013, the entire contents of which are incorporated herein by reference.

### BACKGROUND OF THE INVENTION

(a) Field of the Invention

The present invention relates to a terminal and a method of controlling touch operations in the terminal. To be specific, the present invention relates to a terminal user interface (UI) using gazes and a method of manipulating the same.

(b) Description of the Related Art

Recently, patents for a method of using a smart terminal using multi-touches are increasing. For example, iPhones from Apple Inc. have patents for multi-touches using multiple fingers and Android phones have a screen manipulating technology of a multi-touch method using multiple fingers. Requests for a future-oriented smart terminal user interface (Up and a method of using the same are increasing.

A method of using an information and communication technology (ICT) device through eye-tracking completely focuses on eye movements such as gazes and eye blinking. However, a technology using only eye movements may not realize various gestures such as multi-touches. On the other hand, in the case of a smart terminal such as a smart phone, a smart pad, and an electronic book, since a user holds a terminal by hand in most cases, terminal control does not need to be limited only to gazes.

An eye-tracking technology has been researched for a long time. Recently, a technology of manipulating a smart TV by gazes was developed by applying eye-tracking technology to a smart TV.

On the other hand, in the case of a UI using only eye-tracking, due to serialization of eye movements (a series of eye movements are required), a long response time is required. Therefore, the UI using only eye-tracking is not suitable for a smart terminal that requires a high response speed, unlike a TV. In addition, recent smart terminal applications require a multi-touch UI.

### SUMMARY OF THE INVENTION

An object of the present invention is to provide a future-oriented smart terminal user interface (UI) based on a behavior pattern of a user who uses a smart terminal. To be specific, an object of the present invention is to provide a smart terminal UI capable of providing a multi-touch method as a smart terminal UI to which an eye-tracking technology is applied, and a method of manipulating the same.

According to an exemplary embodiment of the present invention, a terminal is provided. The terminal includes an eye-tracking unit for tracking a gaze of a user to generate gaze information, a touch sensing unit for sensing a touch of the user to generate touch information, and a controller for performing a touch operation based on the gaze information and the touch information.

The touch sensing unit includes a sensor for sensing a touch of the user. The sensor is positioned in a region other than a screen region.

The region other than the screen region may be a rear surface of the terminal, a side surface of the terminal, and a frame region obtained by excluding the screen region from a front surface of the terminal.

The gaze information may represent a point at which the user gazes at the screen region.

The gaze information may represent a movement of the gaze of the user at the screen region.

The touch sensing unit generates the touch information based on the number of touches of the user and touch duration time of the user.

The controller performs a screen zoom operation when the touch information represents two touches and the gaze information represents the movement of the gaze of the user.

The eye-tracking unit includes an eyeball measuring unit for measuring an eyeball distance between the terminal and the eyeballs of the user and an eyeball position of the user, and a gaze information generator for tracking the gaze of the user using the eyeball distance and the eyeball position and generating the gaze information corresponding to the tracking result.

The eyeball measuring unit may output an error message when the eyeball distance deviates from a first reference range or the eyeball position deviates from a second reference range.

The eyeball measuring unit may reconfigure a first reference range when the eyeball distance deviates from the first reference range.

In addition, according to another exemplary embodiment of the present invention, a method of controlling a touch operation in a terminal is provided. The touch operation controlling method includes sensing a touch of a user to generate touch information, tracking a gaze of the user to generate gaze information, and performing a touch operation based on the touch information and the gaze information.

### BRIEF DESCRIPTION OF THE DRAWINGS

FIG. 1 is a view illustrating a concept of an input user interface (UI) according to an exemplary embodiment of the present invention.

FIG. 2 is a view illustrating a structure of a terminal according to an exemplary embodiment of the present invention.

FIG. 3 is a view illustrating a functional configuration of a terminal according to an exemplary embodiment of the present invention.

FIG. 4 is a view illustrating a configuration of the eye-tracking unit of FIG. 3.

FIG. 5 is a flowchart illustrating touch operation control processes according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

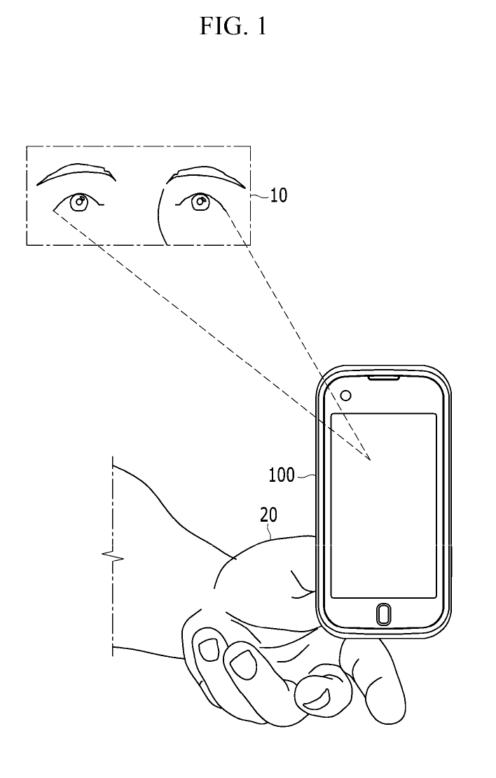

FIG. 1 is a view illustrating a concept of an input user interface (UI) according to an exemplary embodiment of the present invention.

The present invention relates to an input UI for controlling a smart terminal (hereinafter, “terminal”) through a combination of gazes and touches of a user in which not only single touches but multi-touches may be made. A technology for controlling a terminal by voice may be affected by surrounding noise or may generate noise to disturb surrounding people. Therefore, in order to manipulate a terminal without disturbing surrounding people in a public place or while walking along a street, according to the present invention, gazes and hand operations of a user are used.

A terminal 100 may determine an input intension of a user from a gaze 10 of the user and a hand operation 20 of the user.

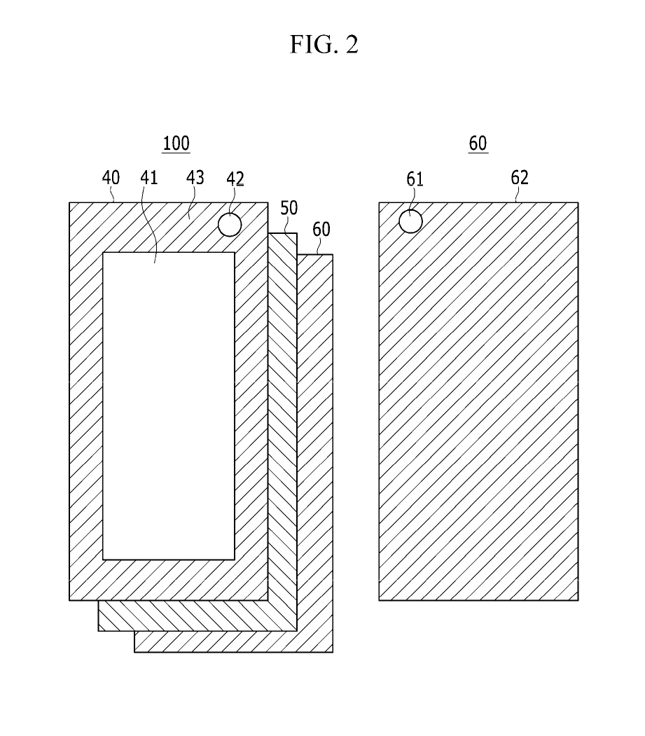

FIG. 2 is a view illustrating a structure of the terminal 100 according to an exemplary embodiment of the present invention.

A front surface 40 of the terminal 100 includes a screen region 41, a front camera 42, and a bezel region 43. Here, the bezel region 43 means a frame region obtained by excluding the screen region 41 from the front surface 40 of the terminal 100.

The terminal 100 includes an internal substrate 50.

A rear surface 60 of the terminal 100 includes a rear camera 61 and a rear surface region 62. The rear surface region 62 includes a sensor capable of sensing touches of a user.

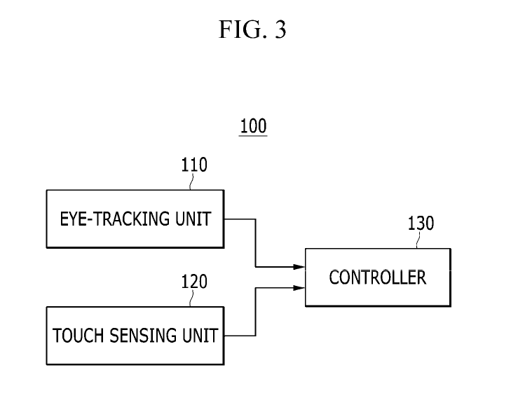

FIG. 3 is a view illustrating a functional configuration of the terminal 100 according to an exemplary embodiment of the present invention.

The terminal 100 includes an eye-tracking unit 110, a touch sensing unit 120, and a controller 130.

The eye-tracking unit 110 tracks a gaze of a user to generate gaze information. The gaze information may represent a point at which the user gazes at the screen region 41. In addition, the gaze information may represent a movement of the gaze of the user (for example, the movement of the gaze from a first point to a second point) in the screen region 41. On the other hand, since an eye-tracking algorithm used by the eye-tracking unit 110 is already well-known to a person of ordinary skill in the art, a detailed description thereof will be omitted.

The touch sensing unit 120 senses touches of the user to generate touch information. The touch sensing unit 120 includes a sensor for sensing the touches of the user. The sensor is positioned in a region other than the screen region 41. The region other than the screen region 41 may be at least one of the bezel region 43, the rear surface region 62, and a side surface (not shown) of the terminal 100. The touch information may represent the number of touches of the user (i.e., the number of fingers that contact the sensor) and touch duration time (i.e., time for which the fingers contact the sensor). For example, the touch duration time may inform that the user makes the touches for a short time and the user makes the touches for a long time.

The controller 130 performs touch operations based on gaze information and touch information. The touch operations mean the operations of the terminal 100 performed by input of the user. For example, the touch operations may be screen zoom in and out, click, drag, screen change, and open.

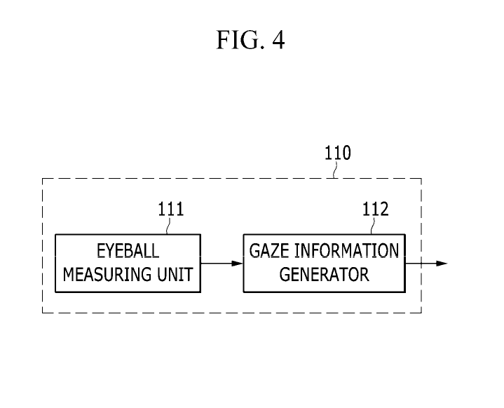

FIG. 4 is a view illustrating a configuration of the eye-tracking unit 110 of FIG. 3.

The eye-tracking unit 110 includes an eyeball measuring unit 111 and a gaze information generator 112.

The eyeball measuring unit 111 measures a distance (hereinafter, “eyeball distance”) between the terminal 100 and the eyeballs of the user and an eyeball position of the user. On the other hand, when the user uses the terminal 100 while walking, the user uses the terminal 100 in a shaking space, or the user uses the terminal 100 while lying his or her face down, eye-tracking must be performed in accordance with the eyeball position of the user. Therefore, the eyeball measuring unit 111 may output an error message when a current eyeball distance deviates from a first reference range or a current eyeball position deviates from a second reference range. The first reference range as an eyeball distance value used for the eye-tracking algorithm of the eye-tracking unit 110 is configured by the user when the terminal 100 is used. For example, the user gazes at at least one point suggested by the terminal 100 or an application when the terminal 100 is unlocked or when the application is executed to configure the first reference range. The second reference range as an eyeball position value used for the eye-tracking algorithm of the eye-tracking unit 110 is configured by the user when the terminal 100 is used. When the currently measured eyeball distance or the currently measured eyeball position deviates from the first reference range or the second reference range, the eyeball measuring unit 111 may output the error message that leads the user to move so that the eyeballs of the user may have a proper eyeball distance (i.e., in the first reference range) or may be in a proper eyeball position (i.e., in the second reference range). On the other hand, instead of outputting the error message, the eyeball measuring unit 111 may reconfigure the first reference range or the second reference range. To be specific, when the currently measured eyeball distance or the currently measured eyeball position deviates from the first reference range or the second reference range, the eyeball measuring unit 111 may reconfigure the first reference range or the second reference range. For example, when the first reference range is 30 cm and the currently measured eyeball distance is 20 cm, the eyeball measuring unit 111 may lead the user to reconfigure the first reference range as 20 cm.

The gaze information generator 112 tracks a gaze of the user using the eyeball distance and the eyeball position measured by the eyeball measuring unit 111 to generate gaze information corresponding to the tracking result. To be specific, the gaze information generator 112 may track the gaze of the user using the currently measured eyeball distance and the currently measured eyeball position when the currently measured eyeball distance and the currently measured eyeball position satisfy the first reference range and the second reference range, respectively.

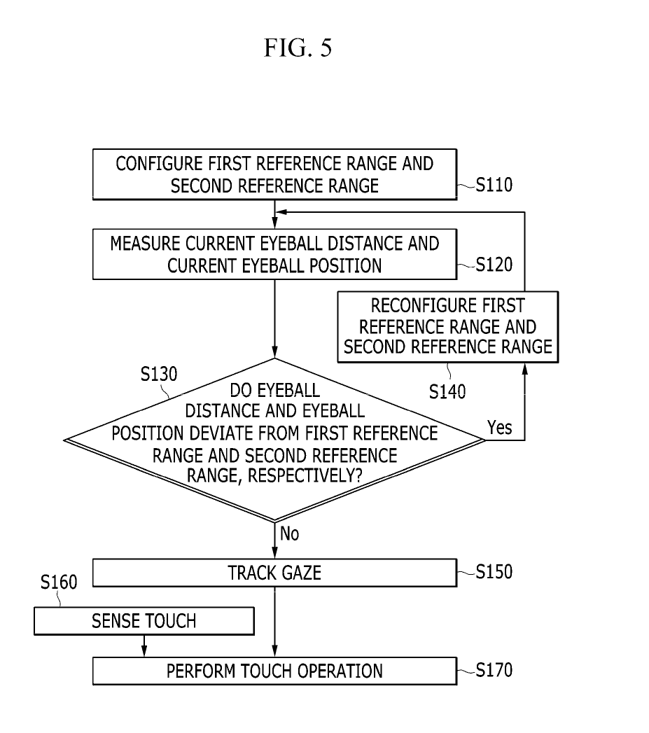

FIG. 5 is a flowchart illustrating touch operation control processes of the terminal 100 according to an exemplary embodiment of the present invention.

The first reference range and the second reference range are configured (S110). For example, when the user unlocks the terminal 100, the user gazes at at least one point suggested by the terminal 100 to configure the first reference range and the second reference range for the eyeball distance and the eyeball position, respectively.

The current eyeball distance and the current eyeball position of the user who uses the terminal 100 are measured (S120).

It is determined whether the measured eyeball distance or the measured eyeball position deviates from the first reference range or the second reference range (S130). When it is determined that the measured eyeball distance deviates from the first reference range, the first reference range is reconfigured, and when it is determined that the measured eyeball position deviates from the second reference range, the second reference range is reconfigured (S140). Then, the process S120 of measuring the current eyeball distance and the current eyeball position is performed again.

When the measured eyeball distance is in the first reference range and the measured eyeball position is in the second reference range, the gaze of the user is tracked through the eye-tracking algorithm (S150). The terminal 100 generates the gaze information through eye-tracking.

On the other hand, a touch of the user is sensed by the sensor positioned in the region (for example, the rear surface region 62) other than the screen region 41 (S160). The user may not continuously gaze at the screen region 41 of the terminal 100 (the user may be walking along a street). Therefore, the gaze of the user must be combined with the operation intension of the user. In the terminal 100, various input operation patterns for use of movies, games, and the Internet exist. The terminal 100 must be able to grasp the operation intension of the user in accordance with the use of the various input operation patterns. The operation intension of the user may be grasped by the sensor of the terminal 100 that senses hand operations of the user. The terminal 100 determines whether the operation intension of the user is one finger, two fingers, three fingers, click, and drag through the number of contacting fingers and contact time of the fingers at the same time when the terminal 100 contacts the sensor. On the other hand, the terminal 100 senses the touch of the user to generate the touch information.

The touch operations are performed based on the gaze information and the touch information (S170). For example, when the touch information represents that the touch is made by one finger for a short time and the gaze information represents that the user gazes at the first point in the screen region 41, the terminal 100 performs the same operation as the operation (for example, execution of an application) performed when the first point is directly touched. As another example, when the touch information represents that a touch state is maintained by one finger and the gaze information represents a movement of the gaze from one point to another point in the screen region 41, the terminal 100 performs the same operation as the operation (for example, scroll) performed when the finger that touches one point in the screen region 41 is dragged and moved to another point. As still another example, when the touch information represents that the touch is made by two fingers and the gaze information represents the movement of the gaze from one point to another point in the screen region 41, the terminal 100 performs the same operation as the operation (for example, screen zoom in and out) performed when a distance between two fingers that touch two points in the screen region 41 is reduced or increased. As still another example, when the touch information represents that the touch is made by two fingers and the gaze information represents the movement of the gaze from one point to another point in the screen region 41, the terminal 100 changes a current screen (for example, a background screen) into another screen.

On the other hand, in FIG. 5, the case in which the first reference range or the second reference range is reconfigured when the measured current eyeball distance or position deviates from the first reference range or the second reference range is illustrated. However, a process of outputting an error message may be performed instead of the reconfiguration process (S140). The error message leads the user to move so that the eyeballs of the user have the proper eyeball distance (i.e., in the first reference range) or may be in the proper eyeball position (i.e., in the second reference range).

According to the exemplary embodiment of the present invention, a smart terminal may be controlled by combining the gaze of the user and the touch of the user that holds the smart terminal in their hands. Therefore, according to the exemplary embodiment of the present invention, since various input gestures may be realized, it is possible to overcome limits of manipulation of the smart terminal that are generated when a device is controlled only by the gaze.

In addition, according to the exemplary embodiment of the present invention, unlike the input UI in which voice is used, since the terminal does not disturb surrounding people, the terminal may be conveniently used in a public place.

Further, according to the exemplary embodiment of the present invention, it is possible to provide the future-oriented smart terminal UI and the method of manipulating the same.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A terminal, comprising:
an eye-tracking unit for tracking a gaze of a user to generate gaze information;
a touch sensing unit for sensing a touch of the user to generate touch information; and
a controller for performing a touch operation based on the gaze information and the touch information.

2. The terminal of claim 1,
wherein the touch sensing unit comprises a sensor for sensing the touch of the user,
wherein the sensor is positioned in a region other than a screen region.

3. The terminal of claim 2, wherein the region other than the screen region is a rear surface of the terminal.

4. The terminal of claim 2, wherein the region other than the screen region is a side surface of the terminal.

5. The terminal of claim 2, wherein the region other than the screen region is a frame region obtained by excluding the screen region from a front surface of the terminal.

6. The terminal of claim 2, wherein the gaze information represents a point at which the user gazes at the screen region.

7. The terminal of claim 2, wherein the gaze information represents a movement of the gaze of the user at the screen region.

8. The terminal of claim 2, wherein the touch sensing unit generates the touch information based on the number of touches of the user.

9. The terminal of claim 8, wherein the touch sensing unit generates the touch information based on the number of touches of the user and touch duration time of the user.

10. The terminal of claim 1, wherein the controller performs a screen zoom operation when the touch information represents two touches and the gaze information represents the movement of the gaze of the user.

11. The terminal of claim 1, wherein the eye-tracking unit comprises:
an eyeball measuring unit for measuring an eyeball distance between the terminal and the eyeballs of the user and an eyeball position of the user; and
a gaze information generator for tracking the gaze of the user using the eyeball distance and the eyeball position and generating the gaze information corresponding to the tracking result.

12. The terminal of claim 11, wherein the eyeball measuring unit outputs an error message when the eyeball distance deviates from a first reference range or the eyeball position deviates from a second reference range.

13. The terminal as claimed in claim 11, wherein the eyeball measuring unit reconfigures a first reference range when the eyeball distance deviates from the first reference range.

14. A method of controlling a touch operation in a terminal, the method comprising:
sensing a touch of a user to generate touch information;
tracking a gaze of the user to generate gaze information; and
performing a touch operation based on the touch information and the gaze information.

15. The method of claim 14, wherein tracking a gaze of the user to generate gaze information comprises:
measuring an eyeball distance between the terminal and the eyeballs of the user and an eyeball position of the user;
tracking the gaze of the user using the eyeball distance and the eyeball position; and
generating the gaze information corresponding to the tracking result.

16. The method of claim 15, further comprising reconfiguring a reference range when the eyeball distance deviates from the reference range.

17. The method of claim 14, wherein sensing a touch of a user to generate touch information further comprises sensing a touch of the user through a sensor positioned in a region other than a screen region of the terminal.

18. The method of claim 17, wherein the region other than the screen region is a rear surface of the terminal.

19. The method of claim 17, wherein sensing a touch of a user to generate touch information further comprises generating the touch information based on the number of touches of the user and touch duration time of the user.

20. The method of claim 17, wherein performing a touch operation based on the touch information and the gaze information further comprises performing the same operation as an operation performed when a first point of the screen region is touched when the touch information represents a touch and the gaze information represents the first point of the screen region.
